(19) United States
(12) Patent Application Publication
(10) Pub. No.: US 2007/0121932 A1
(43) Pub. Date: May 31, 2007

(54) Telephone with a Receiver Operated Reed Hook Switch

(75) Inventors: Scott E. Seay, Cumming, GA (US); Darrell L. Eddings, Alpharetta, GA (US)

Correspondence Address: Harold L. Marquis, 100 Galleria Parkway, NW, Suite 1750, Atlanta, GA, 30339, US

(73) Assignee: Telcom Marketing Group, Inc., Cumming, GA (US)

(21) Appl. No.: 11/564,536

(22) Filed: Nov. 29, 2006

Related U.S. Application Data
(63) Continuation-in-part of application No. 10/685,642, filed on Oct. 15, 2003.

(51) Int. Cl. H04M 1/00; H04M 9/00

(52) U.S. Cl. 379/433.01

(57) ABSTRACT

A telephone in which the mechanical tongue for placing the telephone in an on-hook or off-hook state is replaced by a reed switch located in or in close proximity to the cradle of the telephone. The magnet that is an integral part of the receiver on the telephone will activate the reed switch so as to terminate the connection of the telephone with the communication line when the receiver end of the handset is placed in the cradle. The reed switch may be encapsulated in a material and placed in a cavity in one side of the cradle or may be located in the front wall or a separate place in close proximity to the cradle. An electronic phone which does not have an integral magnet can be used to activate the reed switch by placing a magnet for that purpose in the receiver end of the handset.

### CROSS-REFERENCE TO RELATED APPLICATION

This application is a continuation-in-part of copending U.S. utility application entitled, “MAGNETIC HOOK SWITCH,” having Ser. No. 10/685,642, filed Oct. 15, 2003, which is entirely incorporated herein by reference.

### TECHNICAL FIELD

This invention relates to a telephone having a receiver operated reed switch for placing the telephone in an on-hook state when the handset of the telephone is in the handset cradle and in an off-hook state when the handset is absent from the cradle. The reed switch is located in close proximity to the end of the handset having the receiver with a magnet either as an integral part of the receiver or as a separate component specifically to provide a magnetic flux for operating the reed switch.

### BACKGROUND OF THE INVENTION

Mechanical switches have been used for many years to place a telephone either on-hook or off-hook state. This mechanical switch has typically been a tongue which is used to activate an electrical switch to put the telephone in an on-hook or off-hook state.

This tongue assembly is subject to malfunction and abuse by users of the telephone. This is particularly a problem in prisons and jails where telephones are placed for outgoing calls for the benefit of inmates. The tongue of the telephone is frequently abused by prisoners slamming the telephone handset onto the tongue assembly. The tongue assembly is sometimes used by prisoners as a switch to actually make a telephone call. Elimination of the tongue assembly in the telephone housing will significantly reduce the amount of moisture, cleaning fluids and other liquids that previously would have entered the housing through the opening. If the tongue assembly is eliminated then the opening will not be necessary either.

### SUMMARY OF THE INVENTION

The present invention is a telephone having a reed switch for placing the communication line to the telephone in either an on-hook or off-hook state. The telephone of this invention has a handset with two ends with one end having a microphone and the other end having a receiver with an integral magnet which provides a magnetic flux in the operation of the receiver. The reed switch is located in the cradle or in close proximity to the cradle attached to the base unit of the telephone. When the end of the handset with the receiver is placed in the cradle, the magnetic flux provided by the integral magnet of the receiver activates the reed switch. In order to be effected by the integral magnet in the receiver end of the handset, the reed switch must be located in the cradle or in close proximity to the cradle in which the handset rests in the on-hook state. The reed switch can be located inside a cavity on one side of the cradle. Alternatively, the reed switch can be located on the inside of the front of the base unit of the telephone or on a separate plate covering the hole where the tongue of the telephone was previously located. Preferably, the reed switch is encapsulated in a protective material such as a thermoplastic and affixed to a cavity in one side of the cradle.

Preferably, the reed switch is located so that it is in the on-hook position when the end of the handset with the receiver is in the handset cradle. However, the reed switch can be positioned in the off-hook position under these circumstances with the circuit board of the base unit designed to place the communication line in an on-hook position in this position. The reed switch is typically sealed in an inert gas ampoule which is encapsulated in a thermoplastic material.

The reed switch used in this invention can be used with electronic telephones that do not have a magnet as part of the receiver in the handset. Under those circumstances, a magnet with sufficient power to operate the reed switch is placed in the end of the handset with the receiver.

The reed switch can perform the on-hook/off-hook switching of either a conventional or electronic telephone.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of the unassembled telephone of this invention.

FIG. 2 is a perspective view of the telephone of this invention in which the cradle has been installed and the handset is in place in the cradle.

FIG. 3 is a front view of the telephone of this invention with the handset in the cradle.

FIG. 4 is a back view of the telephone of this invention with the reed switch attached to a separate plate prior to assembly of the telephone.

### DETAILED DESCRIPTION OF THE PREFERRED EMBODIMENT

Inmates in prisons frequently abuse the pay telephones made available to them by slamming the telephone handset onto the tongue of the telephone when they are angry. This sometimes damages or destroys the tongue assembly making the telephone inoperable. They also sometimes try to remove the tongue from the telephone to make a utensil or weapon.

Clever inmates have discovered that they can call a number without any money being paid for the call by depressing and releasing the tongue in the right sequence and timing to duplicate the dialing of the number on the key pad on an analog telephone. Skilled inmates can dial as fast in this way as with the key pad.

The telephone of this invention eliminates the possibility of this abuse of the equipment and defrauding the telephone service provider of revenue. This invention replaces the telephone tongue assembly with a reed switch which connects and disconnects the telephone from the outside communication line based upon the proximity of the receiver of the handset to cradle of the telephone where the reed switch is located. The reed switch is activated by the magnet which is an inherent part of the receiver of the handset of the telephone. Thus, there is no tongue assembly to abuse and it is not possible to dial a number by manipulating the reed switch as it is located within the telephone.

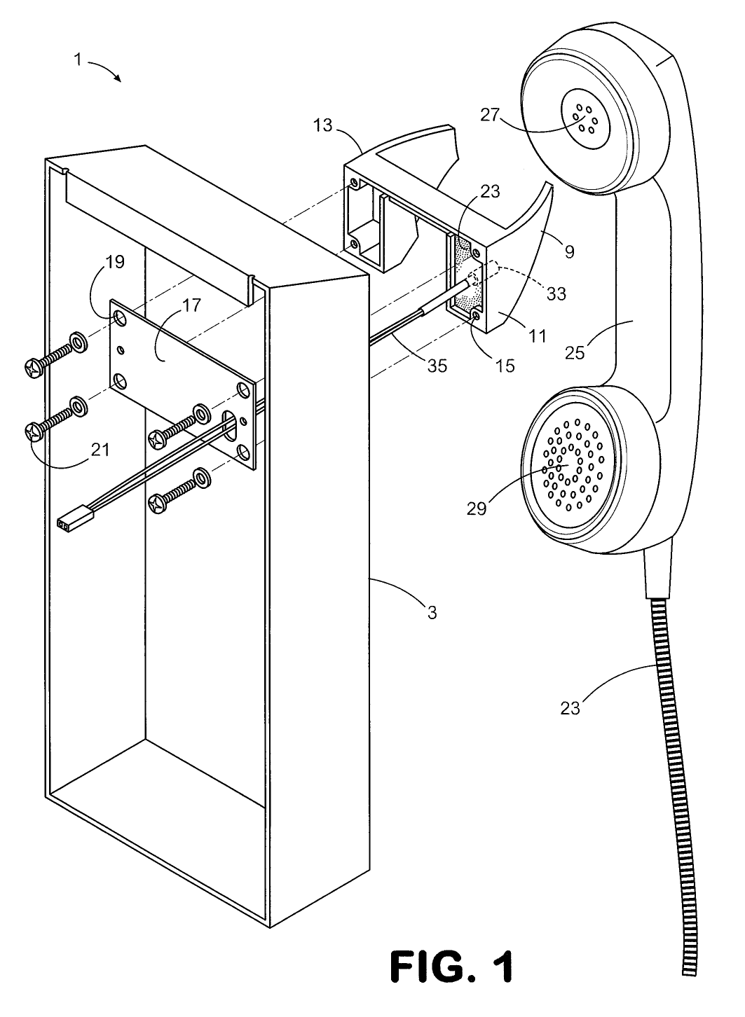

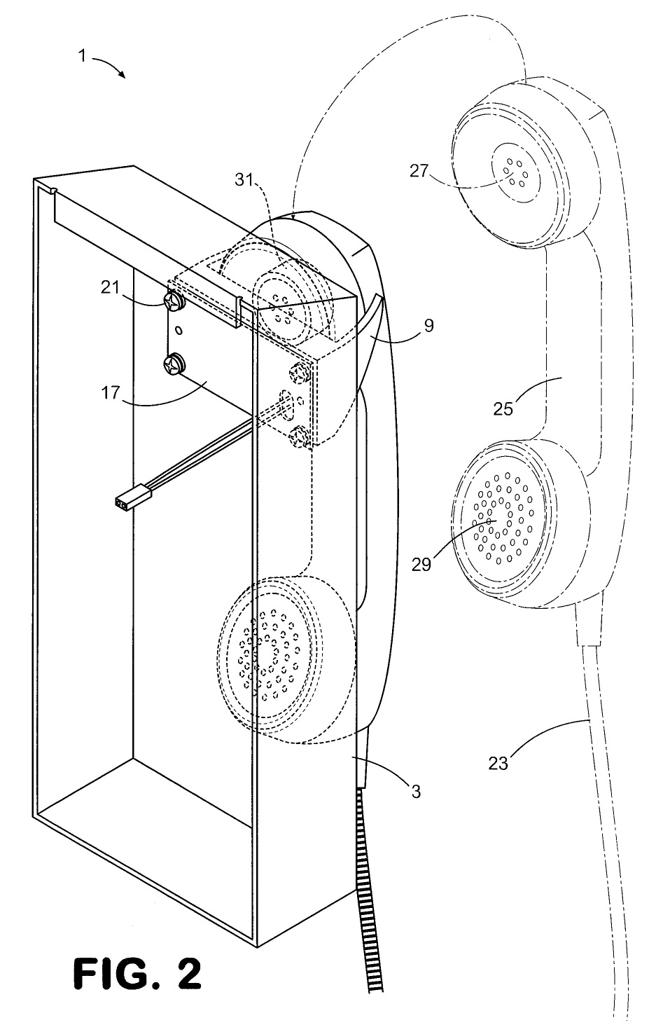

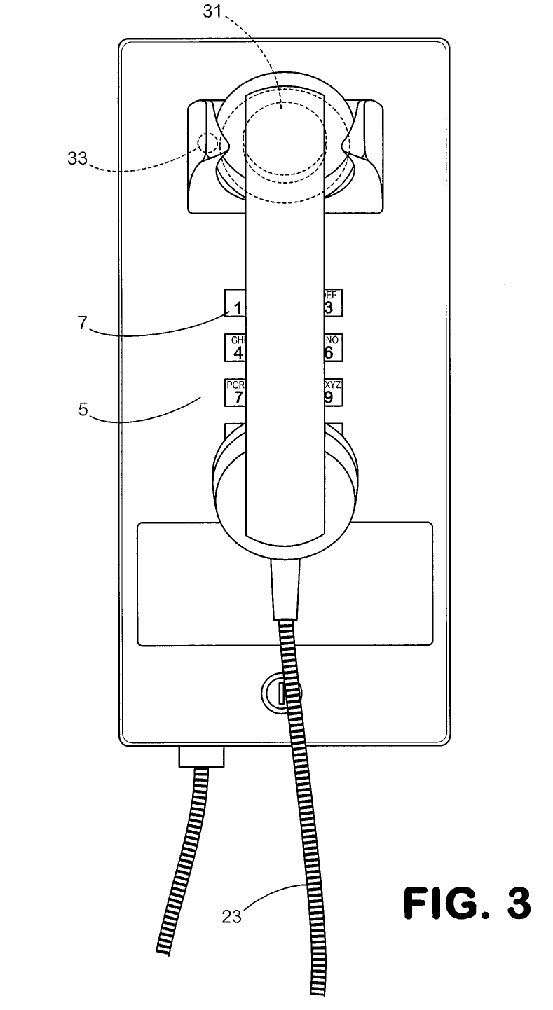

FIGS. 1-3 illustrate one embodiment of the telephone of this invention. The telephone 1 includes a conventional housing 3 which has a front wall 5 with a keypad 7. Attached to the housing 3 is a cradle 9 which has two sides 11, 13. The cradle 9 has threaded holes 15 for use in attachment of the cradle 9 to the housing 3. A separate plate 17 is installed in the housing 3. Plate 17 has plurality of holes 19 which are aligned with the threaded holes 15 in the cradle 9. The cradle 9 is attached to the housing 3 by a plurality of studs 21 which extend through the holes 19 in plate 17 and into the threaded holes 15 of the cradle 9. The telephone 1 has a handset 25 with a receiver 27 and microphone 29. The magnet 31 is an integral part of the receiver 27. This magnet 31 generates a magnetic field around the receiver 27.

A reed switch 33 is installed in one side 11 of the cradle 9. The reed switch 33 generally consists of two elongated metallic contacts that are sealed in the inert gas of an ampoule. The magnetic field generated by the magnet 31 of the receiver 27 will affect the contacts in the reed switch 33 by either bringing them into contact or breaking the contact depending on how the reed switch is constructed. The reed switch 33 must be placed in close proximity to the magnet 31 of the receiver 27 in order to be affected by the magnetic field of the magnet 31. One convenient place to locate the reed switch 33 is in a cavity 23 on one side 11 of the cradle 9. Thus, when the handset 25 is placed in the cradle 9, the magnet 31 in the receiver 27 is in close proximity to the reed switch 33. Preferably, the reed switch 33 is encapsulated in a plastic material that secures it and affixes it in the cavity 23 of the cradle 9. The reed switch 33 has two electrical leads 35 with each being attached to an outside communication line (not shown) and the cord 23 attached to the handset 25.

When the receiver 27 of the handset 25 is placed in the cradle 9 the magnetic effect of the magnet 31 breaks the contact between the contacts in the reed switch 33 which places the telephone in an on-hook status. Alternatively, the reed switch 33 can be constructed so that contact is made when the receiver 27 is in the cradle 9. A circuit board (not shown) controls the operation of the reed switch so that the telephone is in an on-hook status when the receiver 27 is in the cradle 9 and is in an off-hook status when the receiver 27 is out of the cradle 9. This telephone houses a conventional circuit board for controlling its operations.

It has been learned that the reed switch generally has to be placed approximately ¼ inch from the magnet 31 which is an integral part of the receiver in a conventional telephone.

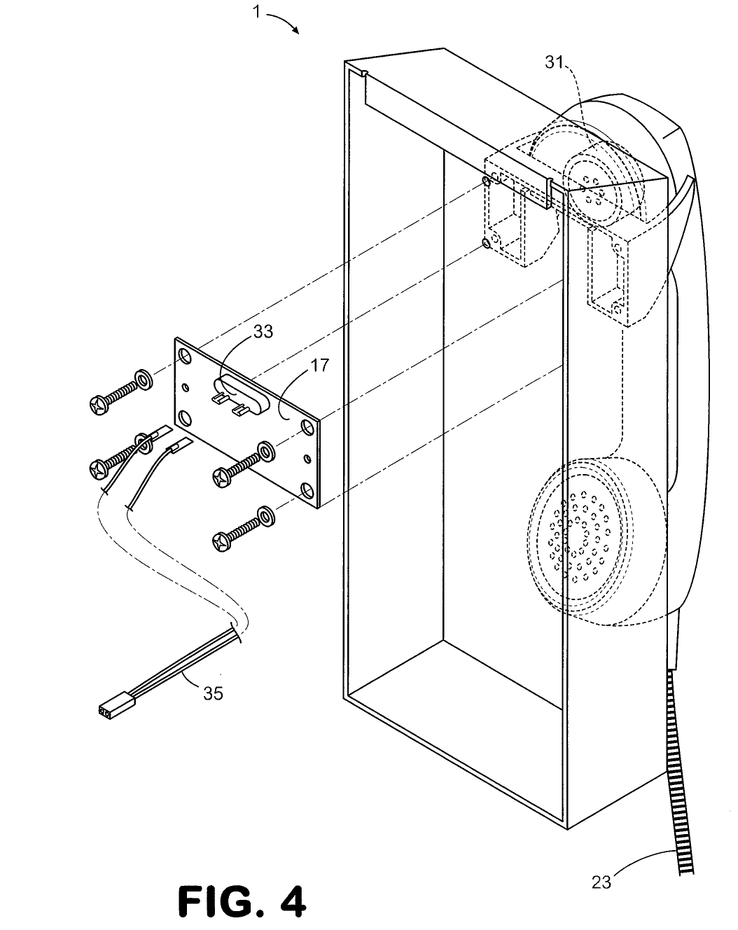

FIG. 4 represents an alternative embodiment for placement of the reed switch 33. In this case, the reed switch 33 is placed on a separate plate 17 which is installed on the front wall 5 of the telephone 1 in close proximity to the magnet 31 of the receiver 27. It should be realized that it is not necessary to have plate 17 as the cradle 9 could be installed directly on the front wall 5 of the housing 3. In this case, the reed switch 33 could be placed on the back surface of the front wall 5 of the housing 3 in close proximity to the receiver 27. If the reed switch 33 is installed on the plate 17 or on the back of the front wall 5, it is preferable that it be encapsulated in a plastic material to protect it from damage and corrosion.

The reed switch used in the telephone of this invention can also be used with an electronic telephone with a digital microphone and receiver by providing a magnet in the end of the handset having the receiver. This magnet will provide the necessary magnetic field to affect the reed switch 33 located in close proximity to it.

Therefore, having thus described the invention, at least the following is claimed:

1. A telephone comprising:
a handset having two ends with one end having a microphone, and the other end having a receiver with an integral magnet which provides a magnetic flux in the operation of the receiver;
a base unit connected to a communication line and said handset and operable to receive signals from said microphone for transmission to said communication line and to transmit signals from said communication line to said receiver, said base unit having a handset cradle in which the end of handset with the receiver can be placed, said base unit having a circuit board for controlling the communication between the telephone and communication line, said base unit having a reed switch located in close proximity to the receiver of the handset when the receiver is resting in the handset cradle, said reed switch being connected to the communication line, said reed switch being affected by the magnetic flux of the magnet of the receiver of the hand set when the end of the handset with the receiver is in the handset cradle so as to place the communication line in either an on-hook or off-hook state;
wherein said reed switch is encapsulated in a protective material.

2. The telephone of claim 1 in which the reed switch is in the on-hook position when the end of the handset with the receiver is in the handset cradle.

3. The telephone of claim 1 in which the reed switch is in the off-hook position when the end of the handset with the receiver is in the handset cradle with the circuit board being designed to place the communication line in an on-hook position in this state and in an off-hook position when the handset is removed from the handset cradle.

4. The telephone of claim 1 in which the handset cradle has two sides for holding the end of the handset with the receiver with the reed switch being located in one of the sides of the handset cradle.

5. The telephone of claim 1 in which the base unit has a front wall to which the handset cradle is attached and the reed switch is located adjacent the front wall in proximity of the end of the handset with the receiver when it is in the handset cradle.

6. The telephone of claim 1 in which the base unit has a front wall to which the handset cradle is attached and a plate is attached to the front wall with the reed switch being located adjacent the plate in proximity to the end of the handset with the receiver when it is in the handset cradle.

7. The telephone of claim 4 in which one of the sides of the cradle has a cavity in which the protective material in which the reed switch is encapsulated is a thermoplastic material which fixes the encapsulated reed switch securely in the cavity.

8. The telephone of claim 2 in which the handset cradle has two sides for holding the end of the handset with the receiver and in which one side of the cradle has a cavity in which the protective material in which the reed switch is encapsulated is a thermoplastic material which fixes the encapsulated reed switch securely in the cavity.

9. An electronic telephone comprising:
a handset having two ends with one end having a digital microphone, and the other end having a digital receiver and having a magnet to provide a magnetic flux;
a base unit connected to a communication line and said handset and operable to receive signals from said microphone for transmission to said communication line and to transmit signals from said communication line to said receiver, said base unit having a handset cradle in which the end of handset with the receiver can be placed, said base unit having an electronic unit for controlling the communications between the telephone and communication line, said base unit having a reed switch located in close proximity to the magnet of the handset when the receiver is resting in the handset cradle, said reed switch being connected to the communication line, said reed switch being affected by the magnetic flux of the magnet in the handset when the end of the handset with the receiver is in the handset cradle so as to place the communication line in either an on-hook or off-hook state;
wherein said reed switch is encapsulated in a protective material.

10. The telephone of claim 9 in which the reed switch is in the on-hook position when the end of the handset with the receiver is in the handset cradle.

11. The telephone of claim 9 in which the handset cradle has two sides for holding the end of the handset with the receiver with the reed switch being located in one of the sides of the handset cradle.

12. The telephone of claim 10 in which the handset cradle has two sides for holding the end of the handset with the receiver with the reed switch being located in one of the sides of the handset cradle.

13. The telephone of claim 9 in which the handset cradle has two sides for holding the end of the handset with the receiver and in which one side of the cradle has a cavity in which the reed switch is encapsulated in a protective material in which the reed switch is encapsulated is a thermoplastic material which fixes the encapsulated reed switch securely in the cavity.

14. In a telephone with a handset having two ends with one end having a microphone, and the other end having a receiver with an integral magnet which provides a magnetic flux in the operation of the receiver, said receiver and microphone being connected to an outside communication line, said telephone having a base unit with a handset cradle, the improvement in the telephone comprising an antifraud mechanism in which the tongue assembly is replaced by a reed switch located in close proximity to the receiver of the handset when the receiver is resting in the handset cradle, said reed switch being connected to the communication line, said reed switch being affected by the magnetic flux of the magnet of the receiver of the hand set when the end of the handset with the receiver is in the handset cradle so as to place the communication line in either an on-hook or off-hook stat.
